(19) United States
(12) Patent Application Publication
(10) Pub. No.: US 2026/0091815 A1
(43) Pub. Date: Apr. 2, 2026

(54) CARGO CART SECUREMENT STRAP SYSTEM

(71) Applicant: Kena Cathleen Maxwell, Tallahassee, FL (US)

(72) Inventor: Kena Cathleen Maxwell, Tallahassee, FL (US)

(21) Appl. No.: 18/904,190

(22) Filed: Oct. 2, 2024

(51) Int. Cl. B62B 3/00; B62B 3/02

(52) U.S. Cl. CPC B62B 3/005; B62B 3/02

(57) ABSTRACT

An extendable strap system for closing off one or more sides of a cargo cart. In a first embodiment the strap system includes a reel assembly mounted within one of the columns of the cart itself—and integral to the cart. When additional securement is desired, the user pulls a strap from the reel assembly and stretches it across an open side of the cart before securing it in place. When the strap is no longer needed it can be returned to the reel assembly.

### BACKGROUND OF THE INVENTION

### 1. Field of the Invention.

This invention relates to the field of cargo securement. More specifically, the invention comprises an extendable strap system for selectively securing one or more open sides of a cargo cart such as a luggage cart.

### 2. Description of the Related Art.

The present invention is applicable to a wide variety of prior art cargo transportation devices. The illustrated embodiments pertain to a luggage cart. However, those skilled in the art will readily appreciate how the invention can be adapted to other devices and the scope of the invention should be fixed by the claims rather than the illustrated embodiments.

FIG. 1 shows a typical luggage cart 10. It is not labeled “prior art” because it has been modified according to the present invention. This “BACKGROUND” section describes the prior art features of the luggage cart shown. The novel features will be described later in this disclosure. Rigid platform 12 mounts a wheel assembly 14 on each of its four corners. At least two of the wheels are usually free-castering. Locking features are often also included to inhibit rotation of the wheels when the cart is parked. Two columns 16,18 are provided on a first end of the platform. Support structure 21 connects the tops of these columns 16,18. End grate 32 closes off the area between the two columns 16,18.

Two columns 20,22 are provided on the second end of the platform. Support structure 26 connects the tops of these columns. End grate 34 closes off the area between columns 20,22. A beam 28 runs between support structure 24 and support structure 26.

The function of the cart 10 will be familiar to those knowledgeable in the field. Hand-portable luggage is loaded on platform 12. Hanging items may be hung from beam 28. The luggage is often stacked—with each column of luggage containing two or more individual pieces. End grates 32,24 prevent the luggage escaping from the ends of the cart. However, the area between columns 16 and 20 and the area between columns 18 and 22 remain open. When the cart is being moved it is known for luggage to tumble through these open areas. This problem is particularly acute where the cart is pushed over uneven surfaces—such as curbs and pavement expansion joints. Sloping terrain causes problems as well.

Carts such as shown in FIG. 1 are not just used to move luggage. In high-rise vacation condominiums, it is customary to provide such carts for the transportation of many items from the parking deck to the upper floors. The carts are often used to transport grocery items and prepared food items. The prepared food items may be in awkwardly shaped containers—such as large and fragile serving dishes. These items readily shift and may fall out the open sides of the cart. The present invention provides a solution for this problem—among other problems.

### BRIEF SUMMARY OF THE INVENTION

The present invention comprises an extendable strap system for closing off one or more sides of a cargo cart. In a first embodiment the strap system includes a reel assembly mounted within one of the columns of the cart itself—and integral to the cart. When additional securement is desired, the user pulls a strap from the reel assembly and stretches it across an open side of the cart before securing it in place. When the strap is no longer needed it can be returned to the reel assembly.

In a second embodiment an external reel assembly is provided. This external reel assembly can be attached to a column. An extendable strap can be pulled from the external reel assembly and secured across an open side of the cart. When the strap is no longer needed, the strap is reeled back into the reel assembly and the reel assembly itself can then be removed from the cart.

### BRIEF DESCRIPTION OF THE SEVERAL VIEWS OF THE DRAWINGS

FIG. 1 is a perspective view, showing a luggage cart modified according to the present invention.

FIG. 2 is a plan view, showing an embodiment of the inventive reel assembly.

FIG. 3 is an exploded perspective view, showing additional components of the inventive reel assembly.

FIG. 4 is a perspective view, showing the embodiment of FIG. 3 in an assembled state.

FIG. 5 is a perspective view, showing the securement of the free end of the strap.

FIG. 6 is a perspective view, showing a luggage cart with the present invention in a deployed state.

FIG. 7 is an exploded perspective view, showing an alternate embodiment of the reel assembly.

FIG. 8 is a perspective view, showing still another embodiment of the reel assembly.

FIG. 9 is a perspective view, showing a luggage cart with the present invention in a deployed state.

### REFERENCE NUMERALS IN THE DRAWINGS

10 luggage cart
12 platform
14 wheel assembly
16 column
18 column
20 column
22 column
24 support structure
26 support structure
28 beam
30 through holes
32 end grate
34 end grate
36 strap
38 strap
40 strap attachment
42 strap attachment
44 reel assembly
46 removable cover
48 hook
50 slot
52 grommet
54 opening
56 flange
58 flange
60 threaded receiver
62 mounting bracket
64 toothed flange
66 pawl mechanism
68 fastener
70 through hole
72 release
74 opening
76 integrated reel and cover
78 slot
80 snap
82 slot
84 external reel assembly
86 enlarged hook
88 strap
90 strap latch
91 column receiver
92 slot
94 strap

### DETAILED DESCRIPTION OF THE INVENTION

The following detailed descriptions pertain to a few selected embodiments of the present invention. Having reviewed this disclosure, many more embodiments will occur to those skilled in the art. Accordingly, the scope of the present invention should be fixed by the claims presented rather than the examples described.

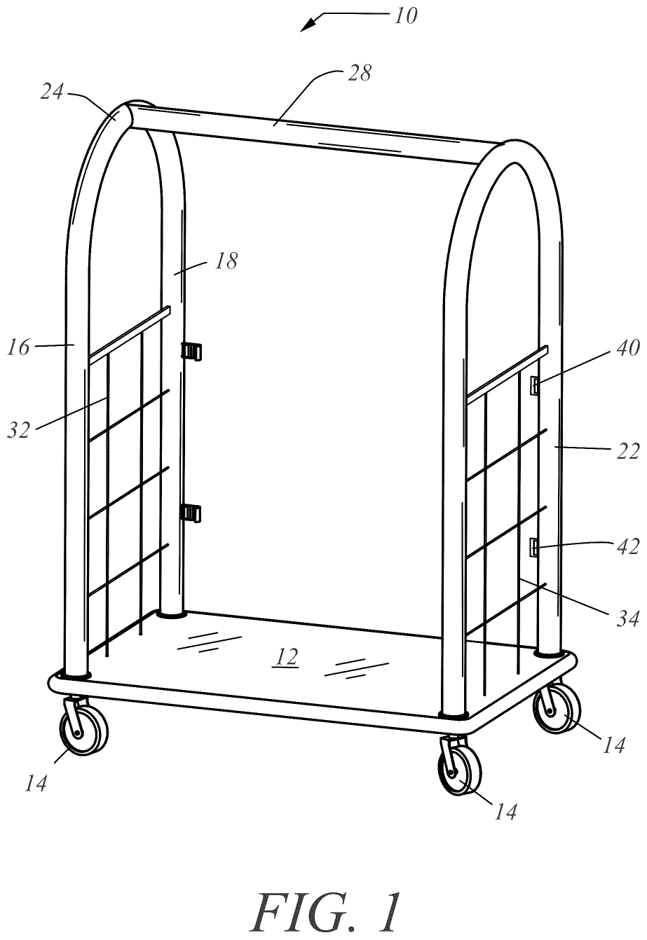

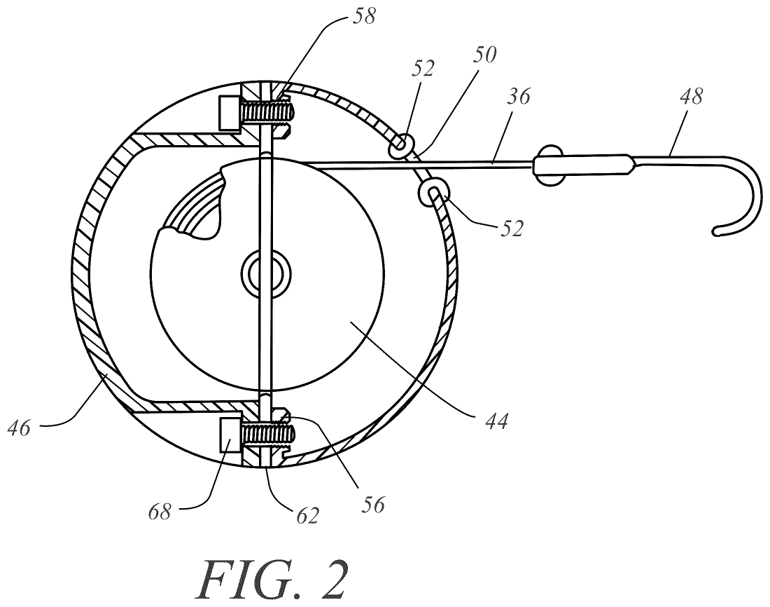

FIG. 1 provides a perspective view of a luggage cart 10 as described previously. Items placed on the cart are constrained by the end grates 32,34. However, these items are also free to escape through the first area in between columns 18 and 22 and the second area in between columns 16 and 20. One or more extendable straps are added to the cart to address this problem. Straps 36 and 38 are mounted on reel assemblies contained within column 18. Strap 36 is configured to be selectively extended and secured to strap attachment 40. Likewise, strap 38 is configured to be selectively extended and secured to strap attachment 42. Section view call-outs for FIG. 2 are provided in FIG. 1.

FIG. 2 provides a plan view through column 18 in the vicinity of reel assembly 44. The reel assembly mounts strap 36. The free end of strap 36 extends out of the column through slot 50. A linking component is secured to the free end of the strap. In this context, the term “linking component” means anything that can be used to attach the strap's free end to another column. Hook 48 is the linking component in this example. Grommet 52 protects the sharp edges of the slot so they will not abrade the strap. Removable cover 46 provides access to the column's interior so that the reel assembly can be installed, serviced, and periodically replaced.

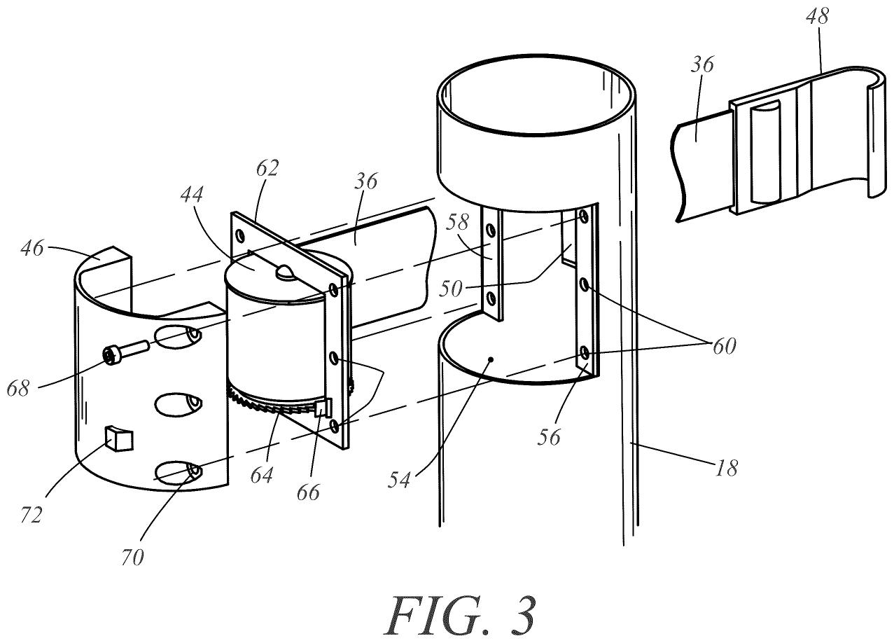

FIG. 3 provides an exploded perspective view of the components depicted in FIG. 2 (The height of column 18 is truncated in the view). Column 18 includes opening 54 for the reel assembly. The column is generally made of thin metal. Flanges 56,58 are formed on each vertical side of opening 54. Each flange includes a plurality of threaded receivers 60 for use in securing other components. The threaded receivers can be formed by tapping pierced holes through the metal of the flange itself. In other examples the threaded receivers are formed by adding a captive threaded fastener—such as a rivet nut (sometimes referred to as a “rivnut”).

Reel assembly 44 is rotatably mounted to mounting bracket 62. The mounting bracket has a set of through-holes 30 positioned to align with threaded receivers 60. Removable cover 46 likewise has a set of through-holes 70 positioned to align with threaded receivers 60. The assembly is connected together by passing fasteners through through-holes 70, through-holes 30, and into threaded receivers 60. By tightening the fasteners, mounting bracket 62 and removable cover 46 are clamped tightly to column 18.

Reel assembly 44 turns within mounting bracket 62 in order to pay out and reel in strap 36. The strap passes out the opposite side of column 18 through slot 50. Hook 48 is attached to the free end of the strap. Reel assembly 44 includes a toothed flange 64. Pawl mechanism 66 is positioned to selectively engage toothed flange 64.

The reel assembly includes a familiar set of mechanisms that are customarily used to control the function of an extendable and retractable strap. An internal constant-force spring (within the reel) is configured to reel in the strap when the pawl mechanism is released. In operation, the user grasps hooks 48 and pulls the strap outward (against the resisting force of the constant-force spring). Once the user engages hook 48 to strap attachment 40 (see FIG. 1), pawl mechanism 66 engages and prevents any further pay out of the strap off the reel assembly. In fact, the strap at this point is firmly secured and resists any further effort to extend the strap.

Release 72 is a push-button (plunger) housed in removable cover 46 and positioned to disengage the pawl in pawl mechanism 66. When the user wishes to disconnect the strap and have it reel itself back onto the reel, the user presses release 72 and disengages the hook. Reel assembly 44 then automatically reels the extended strap back in. Hook 48 is too large to pass through slot 50. Thus, the hook remains available. When the user wishes to reextend the strap he or she grasps the hook and again pulls the strap off the reel assembly.

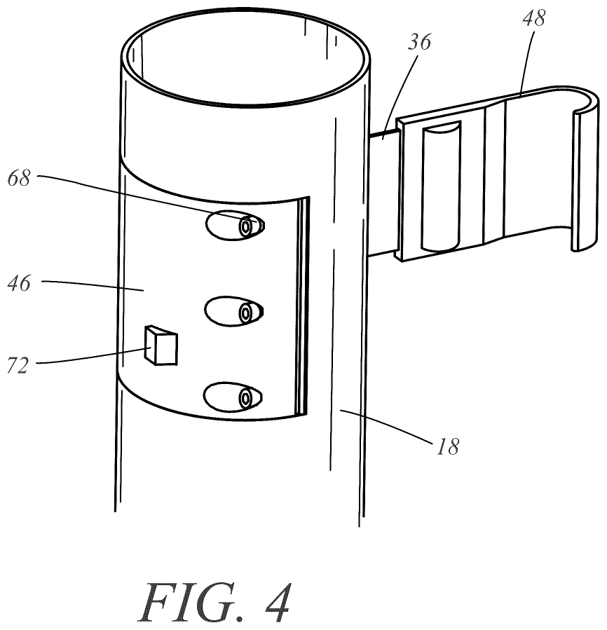

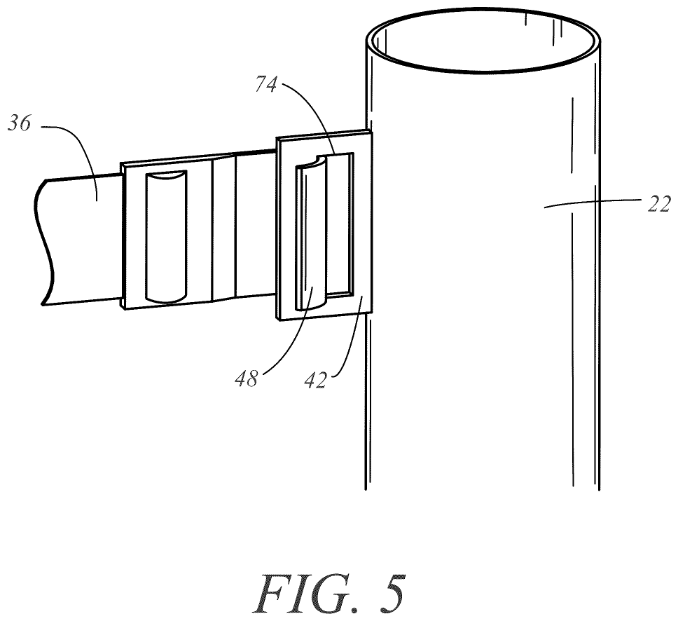

FIG. 4 shows the reel assembly and strap in an assembled state. Removable cover 46 is preferably given a cylindrical outer surface that matches the cylindrical outer surface of column 18. In operation, the user grasps hook 48 and uses it to pull a length of strap 36 free of the column. FIG. 5 shows the hook 48 after it has been used to drag the strap across an open side of the luggage cart. Hook 48 is connected to strap attachment 42 on column 22 by passing the hook through opening 74. At this point the pawl mechanism is engaged and further extension of the strap 36 is not possible. Thus, the strap resists the force of any luggage or other item on the cart trying to push it out of the way.

In order to release the strap for stowage, the user presses release 72. This disengages the pawl mechanism. The user is then free to pull a bit more strap out of the reel assembly in order to provide some slack needed to manipulate hook 48 back through opening 74 and release the hook from its engagement with strap attachment 42. Once the hook is free, the user moves the hook toward the reel assembly and the constant-force spring within the reel smoothly reels in the strap. The engagement and disengagement functions can be carried out in a variety of ways. As an example, some embodiments require the user to push the release a first time in order to place the reel assembly in a state where the strap can be extended. The user then pushes the release a second time to lock the pawl mechanism and thereby lock the reel (preventing extension or retraction). The user then must again press release 72 in order to disengage the hook from the strap attachment 42 and allow the strap to be reeled back in.

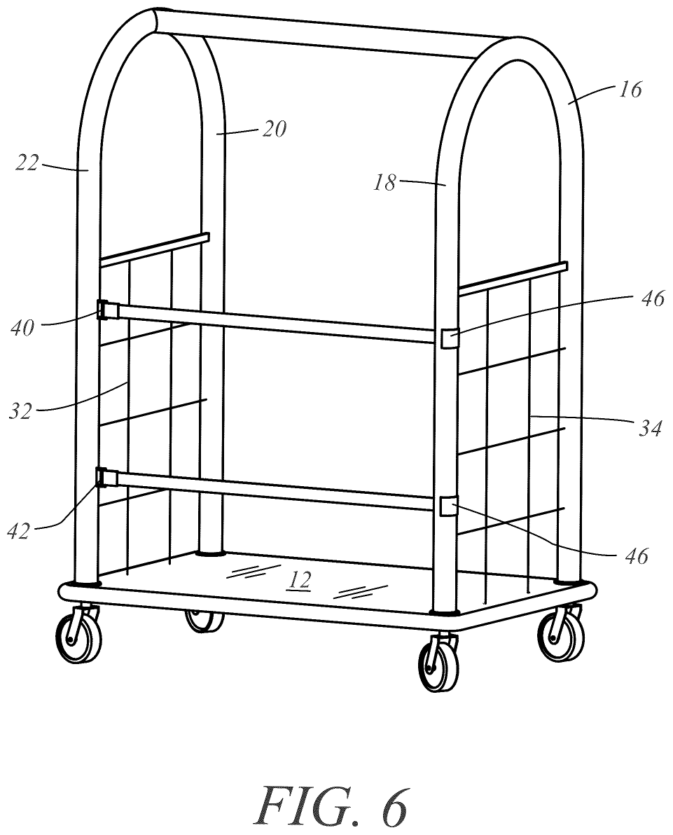

FIG. 6 shows the back side of the luggage cart of FIG. 1 with straps 40,42 extended and attached. The reader will note that strap 36 is connected to strap attachment 40 and strap 38 is connected to strap attachment 42. The two straps close the open rear side of the cart-meaning that the items placed on the cart are now confronted by a constraining barrier on three sides. It is possible to provide additional inventive straps between columns 16 and 20. By deploying these additional straps the items placed on platform 12 can be surrounded on all sides.

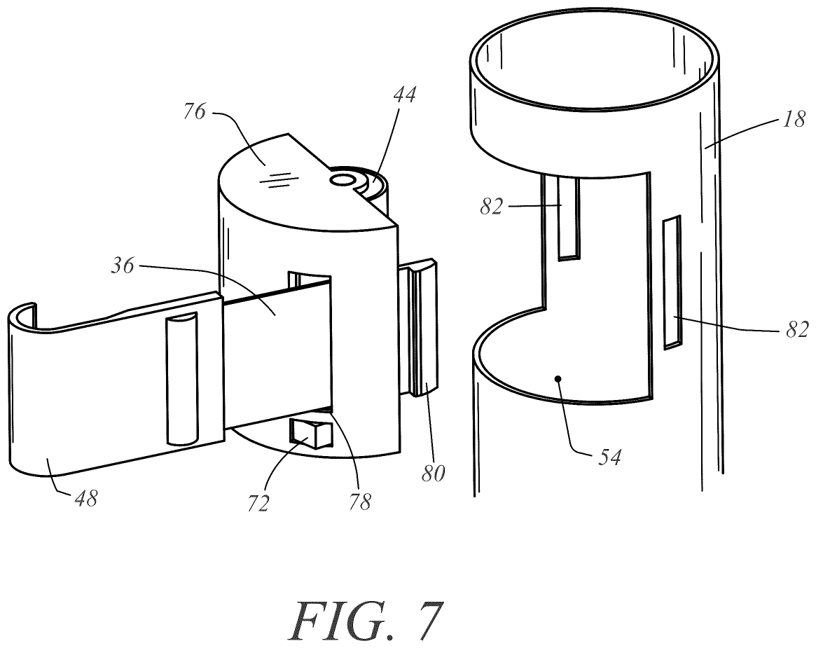

Returning briefly to FIG. 3, those skilled in the art will realize that the functional characteristics of the assembly shown can be achieved using very different components. FIG. 7 shows an alternate embodiment. In this embodiment, the reel assembly and cover are integrated into a single assembly-integrated reel and cover 76. Opening 54 in column 18 does not need the flanges or threaded receivers. Instead a pair of slots 82 are provided proximate the vertical sides of the opening.

Integrated reel and cover 76 is preferably made of a flexible polymer. It includes a pair of extending snaps 80. When the integrated reel and cover is urged into opening 54, the two snaps 80 deflect inward and then an outward-protruding portion of each snap pops out into engagement with its respective slot 82. This retains the integrated reel and cover 76 within opening 54. In order to remove the assembly 76, the user must force the two snaps inward and pull the assembly free from column 18.

In this embodiment opening 54 is provided on the side of column 18 that faces column 22. Slot 78 allows strap 36 to extend out of the assembly in the direction of column 22. Release 72 is provided as for the prior embodiment. This release locks and unlocks the extension and retraction of the strap.

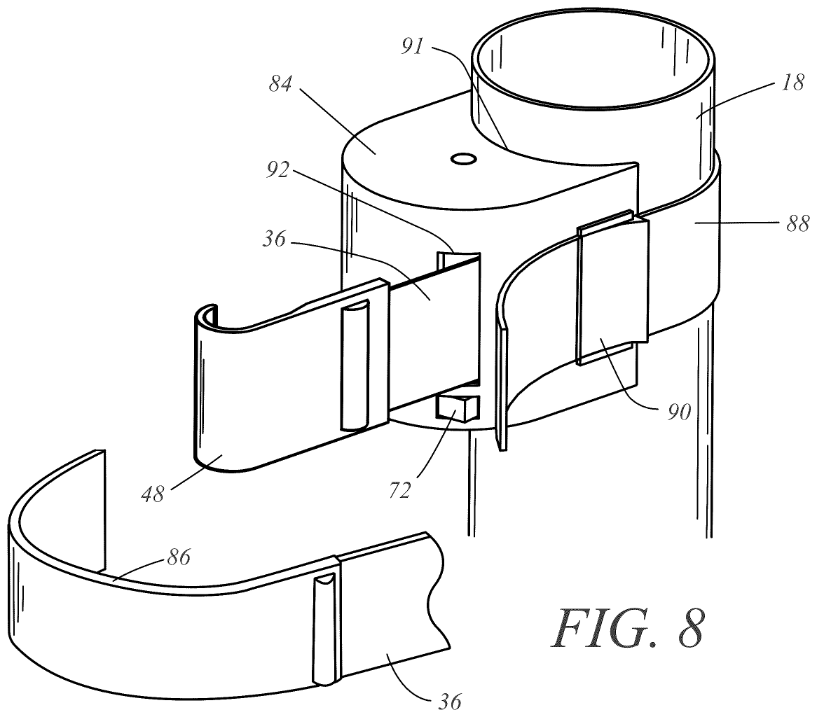

Of course, the embodiments of FIGS. 1-7 require the modification of the luggage cart itself—such as by providing suitable openings in the columns of the cart. It is also desirable to provide an embodiment that can be retrofitted to an existing luggage cart without requiring any modifications to the cart. FIG. 8 shows such an embodiment. External reel assembly 84 contains the same reel and pawl mechanism as for the prior examples. Strap 36 extends out of slot 92 and release 72 selectively locks and unlocks the extension and retraction functions.

However, external reel assembly 84 is not an integral part of column 18. It is instead secured to the exterior of the column using strap 88. The far end of strap 88 attaches to the far side of external reel assembly 84 (not visible in the view). The strap passes around column 18 and through strap latch 90. The user tightens the strap and then locks it in place using strap latch 90. Column receiver 91 has a concave shape designed to receive columns of various diameters. Grip-enhancing features, such as rubber pads, are preferably provided within the surfaces of the column receiver that face the column when the device is installed. Once strap 88 is secured, external reel assembly 84 is held in position against the exterior surface of column 18. The user then grasps enlarged hook 86 and extends strap 36.

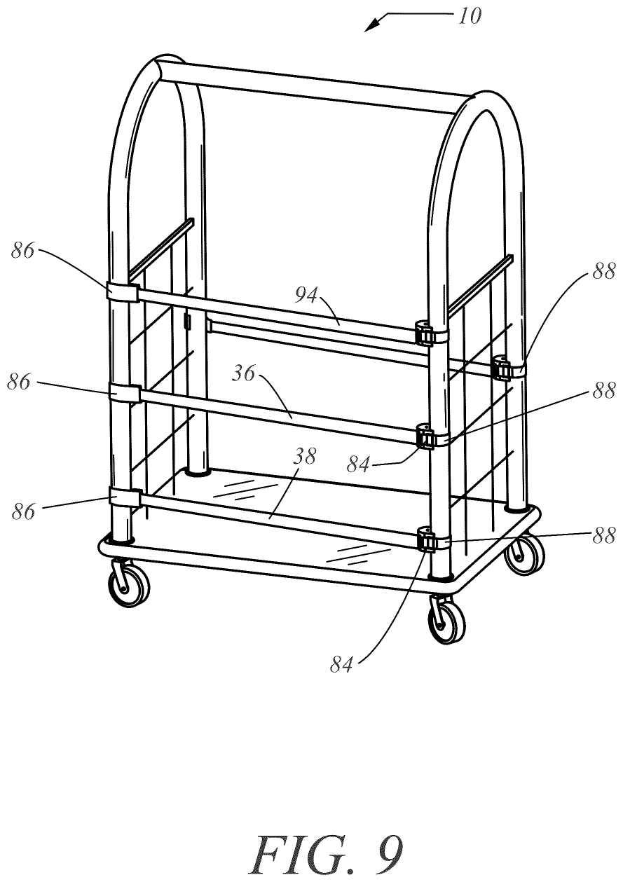

Enlarged hook 86 is preferably made large enough to pass completely around a column on the luggage cart-eliminating the need for a strap attachment on the column to which it is attached. FIG. 9 shows five such embodiments installed on a prior art luggage cart 10. The reader will note how three external reel assemblies 84 are attached to column 18 using their respective straps 88. On the far end of these three straps 94,36,38 are three enlarged hooks 86. The reader will note how these enlarged hooks pass all the way around column 22.

In this exemplary installation, two additional external reel assemblies are used to provide a barrier on the far side of the luggage rack. With the external reel assemblies, the user can add one, two, three, four, or more such assemblies to an existing luggage rack.

The preceding description contains significant detail regarding the novel aspects of the present invention. It should not be construed, however, as limiting the scope of the invention but rather as providing illustrations of the preferred embodiments of the invention. Many other embodiments will be made apparent to those skilled in the art. Thus, the scope of the invention should be fixed by the following claims, rather than by the examples given.

Having described my invention, I claim:

1. A cargo cart, comprising:
(a) a platform;
(b) a plurality of wheel assemblies supporting said platform;
(c) a first column extending upward from said platform;
(d) a second column extending up from said platform, said second column laterally displaced from said first column;
(e) a reel assembly mounted inside said first column;
(f) an extendable strap coiled on said reel assembly, said strap including a free end extending out of said reel assembly;
(g) a linking component mounted on said free end of said strap;
(g) a strap attachment mounted on said second column; and
(h) wherein said linking component is selectably attachable to said strap attachment when said extendable strap is pulled across a gap between said first and second columns.

2. The cargo cart as recited in claim 1, wherein said linking component is a hook.

3. The cargo cart as recited in claim 2, wherein said hook is large enough to pass around said second column.

4. The cargo cart as recited in claim 1, wherein said reel assembly includes a locking mechanism that prevents further extension of said strap.

5. The cargo cart as recited in claim 4, further comprising a user-actuated release for releasing said locking mechanism.

6. The cargo cart as recited in claim 1, further comprising:
(a) wherein said first column includes an opening;
(b) wherein said reel assembly is mounted in said opening; and
(c) a removable cover covering said reel assembly and said opening.

7. The cargo cart as recited in claim 6, wherein said reel assembly is attached to said removable cover.

8. A cargo cart, comprising:
(a) a platform;
(b) a plurality of wheel assemblies supporting said platform;
(c) a first column extending upward from said platform;
(d) a second column extending up from said platform, said second column laterally displaced from said first column;
(e) a reel assembly attached to said first column;
(f) an extendable strap coiled on said reel assembly, said strap including a free end extending out of said reel assembly;
(g) a linking component mounted on said free end of said strap;
(g) a strap attachment mounted on said second column; and
(h) wherein said linking component is selectably attachable to said strap attachment when said extendable strap is pulled across a gap between said first and second columns.

9. The cargo cart as recited in claim 8, wherein said linking component is a hook.

10. The cargo cart as recited in claim 9, wherein said hook is large enough to pass around said second column.

11. The cargo cart as recited in claim 8, wherein said reel assembly includes a locking mechanism that prevents further extension of said strap.

12. The cargo cart as recited in claim 11, further comprising a user-actuated release for releasing said locking mechanism.

13. The cargo cart as recited in claim 8, further comprising:
(a) wherein said first column includes an opening;
(b) wherein said reel assembly is mounted in said opening; and
(c) a removable cover covering said reel assembly and said opening.

14. The cargo cart as recited in claim 13, wherein said reel assembly is attached to said removable cover.

15. A cargo cart, comprising:
(a) a mobile platform;
(b) a first column extending upward from said platform;
(c) a second column extending up from said platform, said second column laterally displaced from said first column;
(d) a reel assembly mounted inside said first column;
(e) an extendable strap coiled on said reel assembly, said strap including a free end extending out of said reel assembly;
(f) a linking component mounted on said free end of said strap; and
(g) wherein said linking component is selectably attachable to said second column when said extendable strap is pulled across a gap between said first and second columns.

16. The cargo cart as recited in claim 15, wherein said linking component is a hook.

17. The cargo cart as recited in claim 16, wherein said hook is large enough to pass around said second column.

18. The cargo cart as recited in claim 15, comprising:
(a) a strap attachment on said second column; and
(b) wherein said linking component selectively attaches to said strap attachment.

19. The cargo cart as recited in claim 15, wherein said reel assembly includes a locking mechanism that prevents further extension of said strap.

20. The cargo cart as recited in claim 19, further comprising a user-actuated release for releasing said locking mechanism.
